(19) United States
(12) Patent Application Publication
(10) Pub. No.: US 2022/0351090 A1
(43) Pub. Date: Nov. 3, 2022

(54) FEDERATED LEARNING METHOD FOR DECISION TREE-ORIENTED HORIZONTAL

(71) Applicant: ZHEJIANG UNIVERSITY, Hangzhou (CN)

(72) Inventors: ZhiHua TIAN, Hangzhou (CN); Rui ZHANG, Hangzhou (CN); Xiaoyang HOU, Hangzhou (CN); Jian LIU, Hangzhou (CN); Kui REN, Hangzhou (CN)

(21) Appl. No.: 17/860,129

(22) Filed: Jul. 8, 2022

Related U.S. Application Data
(63) Continuation of application No. PCT/CN2020/126846, filed on Nov. 5, 2020.

(51) Int. Cl. G06N 20/20; G06N 5/00

(52) U.S. Cl. CPC G06N 20/20; G06N 5/003

(57) ABSTRACT

Disclosed is a federated learning method for decision tree-oriented horizontal. The method comprises the following steps: all participants searching for a quantile sketch of each feature in a data feature set based on dichotomy; the participants constructing a local histogram for each feature by using locally held data features according to the quantile sketch; adding noise satisfying differential privacy to all local histograms, and sending the local histograms to a coordinator after processing through the secure aggregation method; the coordinator merging the local histograms of each feature into a global histogram, and training a root node of a first decision tree according to the histogram; the coordinator sending information of the node to other participants; and all participants updating the local histograms and repeating the above process for training to obtain the trained decision trees.

### CROSS-REFERENCE TO RELATED APPLICATIONS

The present application is a continuation of International Application No. PCT/CN2020/126846, filed on Nov. 5, 2020, the content of which is incorporated herein by reference in its entirety.

### TECHNICAL FIELD

The present disclosure relates to the technical field of federated learning, in particular to a federated learning method for decision tree-oriented horizontal.

### BACKGROUND

Federated learning, also known as collaborative learning, is a machine learning technology that trains models together on multiple decentralized devices or servers that store local data. Different from traditional centralized learning, it is not necessary to merge data together in this method, so data exist independently.

The concept of federated learning was first put forward by Google in 2017, and now it has significantly been developed. The range of its application scenarios is becoming broader and broader. According to how data is partitioned, it can be roughly classified into two horizontal federated learning and vertical federated learning. In horizontal federated learning, researchers distribute the training process of a model among multiple participants, and iteratively aggregate local training models into a joint global model. In this process, there are two main roles: a central server and multiple participants. At the beginning of training, the central server initializes a model and sends it to all participants. In each iteration, each participant trains the received model with local data and sends the training gradient to the central server. The center aggregates the received gradients to update the global model. Due to this way of transmitting intermediate results instead of original data, federated learning has the following advantages: (1) protecting privacy: during the training process, data is still stored on local devices; (2) low latency: the updated model can be used for users to predict on the device; (3) reducing the computational burden: the training process is distributed on multiple devices instead of a single device.

At present, the research on federated learning has made great progress, but its research object is mainly the neural network, thus ignoring the research of other machine learning models. Even though the neural network is one of the most widely studied machine learning models at present, it is still criticized for its poor interpretability, which limits its disclosure in the fields of finance, medical images and so on. On the contrary, the decision tree method is regarded as the gold standard of accuracy and interpretability. Especially, Gradient Boosting Decision Trees have won many machine learning competitions. However, it has not attracted enough attention in the field of federated learning.

### SUMMARY

The purpose of the present disclosure is to provide a federated learning method for decision tree-oriented horizontal, which solves the problems of low efficiency and long running time in the horizontal federated learning process. Under the condition of a minimal precision loss, the present disclosure can complete the training more efficiently and quickly.

The purpose of the present disclosure is realized by the following technical solution: a federated learning method for decision tree-oriented horizontal, wherein the decision tree is Gradient Boosting Decision Trees, and the method comprises the following steps:

(1) All participants searching for a quantile sketch of all data of each feature in a data feature set by dichotomy, and publishing the quantile sketch to all participants.

(2) All participants respectively constructing local histograms of each feature in the data feature set according to the quantile sketch searched in step (1), and adding noise to the local histograms according to the principle of differential privacy.

(3) Subsequently, the participants except a coordinator sending the local histograms added with the noise to the coordinator through secure aggregation, the coordinator is one of all participants.

(4) The coordinator merging the local histograms of each data feature into a global histogram, and training a root node of a first decision tree according to the global histogram.

(5) The coordinator sending node information to other participants, the node information comprises a selected data feature and separation methods corresponding to the data feature in the global histogram.

(6) All participants updating the local histogram according to the node information.

(7) Repeating steps (2)-(6) according to the updated local histograms until the training of remaining child nodes in the first decision tree is completed.

(8) Repeating step (7) until the training of all decision trees is completed to obtain a final Gradient Boosting Decision Trees model.

Furthermore, the data feature set is personal privacy information.

Furthermore, the dichotomy in step (1) specifically comprises:

(a) The coordinator obtaining a total number of samples of all participants through the secure aggregation method.

(b) The coordinator setting the maximum value and the minimum values of each data feature and taking the average of them as the quantile candidate value for that feature.

(c) The coordinator sending the quantile candidate values of all features to other participants, all participants counting the number of samples smaller than the quantile candidate value of each feature in the feature set, respectively, and sending the results to the coordinator via the secure aggregation method, the coordinator thus get the total number of samples smaller than the quantile candidate value of each feature.

(d) The coordinator calculating the data percentage of the quantile candidate value according to the total number of samples that is counted in step (a) and the statistics got in step (c), if the data percentage is less than a data percentage of a target quantile, taking the quantile candidate value as the minimum value, and if the data percentage is greater than the data percentage of the target quantile, taking the quantile candidate value as the maximum value, the mean value as the quantile candidate value is recalculated, and the processes (c)-(d) are repeated until the data percentage of the quantile is equal to the data percentage of the target quantile.

(e) Repeating the processes (b)-(d) to search for remaining quantiles, wherein all quantiles constitute the quantile sketch.

Furthermore, the local histograms are composed of first-order derivatives and second-order derivatives of all samples respectively.

Furthermore, the method of training the root node of the first decision tree according to the global histogram specifically comprises: the coordinator traversing each feature in the data feature set and simultaneously traversing separation methods of the global histogram of the feature, obtaining an optimal separation method by calculation, and vertically divides the global histogram into two parts according to the separation method.

Furthermore, the step (6) comprises the following sub-steps:

(6.1) All participants selecting a corresponding quantile as a value of the node according to the node information returned by the coordinator and referring to the quantile sketch.

(6.2) According to the value of the node, all participants splitting the samples they own to left and right sub-nodes of the node, the samples with feature values smaller than the node value selected in the step (5) into the left sub-node, and the samples with feature values larger than the node value into the right sub-node; and updating the local histograms.

Compared with the prior art, the present disclosure has the following beneficial effects: the present disclosure applies the decision tree to federated learning, which provides a new idea for federated learning; by applying differential privacy and secure aggregation to the method of the present disclosure, the data transmission efficiency is greatly improved, the data security is ensured, and the time required for operation is reduced, so that horizontal federated learning can really be realized in industrial scenarios. The horizontal federated learning method of the present disclosure has the advantages of simple use, high training efficiency and the like, can protect data privacy and provide quantitative support for the data protection level.

### BRIEF DESCRIPTION OF DRAWINGS

FIG. 1 is a flow chart of the federated learning method for decision tree-oriented horizontal according to the present disclosure.

### DESCRIPTION OF EMBODIMENTS

In order to train a model with a higher accuracy and a stronger generalization ability, more diverse data is essential. Although the development of Internet has provided convenience for data collection, the problem of data security is gradually exposed. Restricted by the influence of national policies, the consideration of enterprise interests and the increasing attention of individuals to the protection of privacy, the traditional training mode of combining data is becoming more and more infeasible.

The present disclosure aims at such a scene, that is, the data security of all parties is protected on the premise that the data is still stored locally, a model is jointly trained by using the data of multiple parties, and on the premise of controlling the loss of accuracy.

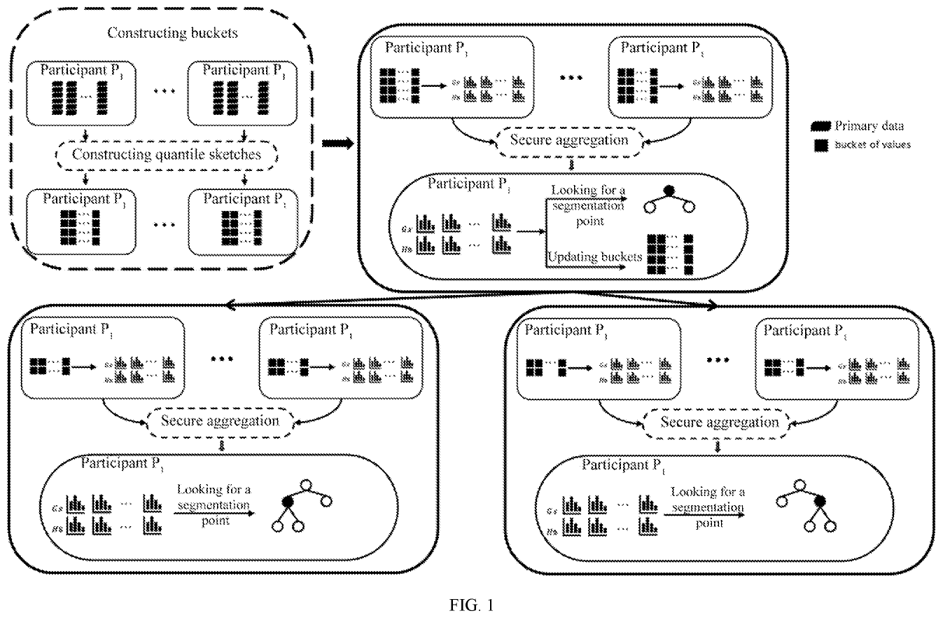

FIG. 1 is a flow chart of a horizontal federated learning method oriented to decision tree of the present disclosure, the decision tree is Gradient Boosting Decision Trees, and the data feature set adopted in the present disclosure is personal privacy information, which specifically includes the following steps:

(1) All participants search for the quantile sketch of all data of each data feature in a data feature set by dichotomy, and publish the quantile sketch to all participants; by this method, the quantile sketch of all data of each feature in the feature set can be obtained without revealing the information of participants; the method for finding the quantile sketch of all data of each data feature in the data feature set by dichotomy is as follows:

(a) The coordinator obtains the total number of samples held by all participants by secure aggregation, and through secure aggregation, the total number of samples held by all participants can be obtained without revealing the number of samples held by a single participant.

(b) The coordinator sets the maximum value and the minimum value of each data feature, and takes the average of them as a quantile candidate value for that feature, and the maximum value and the minimum value can be set according to experience without requirement on accuracy.

(c) The coordinator sends the quantile candidate values of all feature to other participants, all participants count the number of samples smaller than the quantile candidate value of each feature in the feature set respectively, and send the results to the coordinator via the secure aggregation method, the coordinator thus get the total number of samples smaller than the quantile candidate value of each feature without knowing the information of other participants.

(d) The coordinator calculates the data percentage of the quantile candidate value according to the total number of samples that counted in step (a) and the statistics got in step (c); if the data percentage is less than the data percentage of the target quantile, the quantile candidate value is taken as the minimum value; if the data percentage is greater than the data percentage of the target quantile, the quantile candidate value is taken as the maximum value; the mean value thereof is recalculated as the quantile candidate value, and the processes (c)-(d) are repeated until the data percentage of the quantile is equal to or close to the data percentage of the target quantile.

(e) The processes (b)-(d) are repeated to find the remaining quantile, wherein all quantiles constitute the quantile sketch.

(2) All participants respectively construct a local histogram of each feature in the data feature set according to the quantile sketch searched in step (1), and add a noise to the local histogram according to the principle of differential privacy; the local histogram consists of the first-order derivative and the second-order derivative of each sample. By calculating the first-order derivatives and second-order derivatives of all samples locally, and using the quantile sketch to construct the histogram, the leakage of data features can be avoided.

(3) Subsequently, the participants except the coordinator send the local histogram added with the noise to the coordinator through secure aggregation, the coordinator is one of all participants.

(4) The coordinator merges the local histograms of each data feature into a global histogram. Because the quantile sketch is constructed by using all the feature values of each feature, when the local histograms are aggregated into the global histogram, the histograms of each participant can be aligned. The coordinator trains a root node of the first decision tree according to the global histogram, specifically, the coordinator traverses each feature in the data feature set, and at the same time, traverses the separation method of the global histogram of the feature, obtains the optimal separation method by calculation, and longitudinally divides the global histogram into two parts according to the separation method.

(5) The coordinator sends the node information to other participants; the node information includes the selected data features and the separation method of the global histogram corresponding to the data features;

(6) All participants update the local histogram according to the node information, which comprises that following sub-steps:

(6.1) All participants select the corresponding quantile as the value of the node according to the node information returned by the coordinator and referring to the quantile sketch; since the quantile sketch has been published to all participants, selecting the quantile as the value of the node can unify the models built by all participants, and selecting the quantile as the value of the node does not affect the final training model.

(6.2) According to the value of the node, all participants split the samples they own to the left and right sub-nodes of the node, the samples with feature values smaller than the node values selected in step (5) are split to the left sub-node, and the samples with feature values larger than the node values to the right sub-node; and the local histogram is updated.

(7) Steps (2)-(6) are repeated according to the updated local histogram until the training of the remaining child nodes in the first decision tree is completed.

(8) Step (7) is repeated until the training of all decision trees is completed to obtain a final Gradient Boosting Decision Trees model; this step mainly updates the first-order derivative and second-order derivative of the sample, and the histogram is still constructed according to the quantile sketch.

In order to make the purpose, technical solution and advantages of the disclosure clearer, the technical solution of the disclosure will be clearly and completely described with examples below. Obviously, the described examples are only part of, not all of the examples of the disclosure. Based on the examples in the disclosure, all other examples obtained by those skilled in the art without creative work shall fall within the scope of protection of the disclosure.

### EXAMPLES

With the data of four hospitals A, B, C and D, a model was jointly trained by the federated learning method of the present disclosure to calculate the probability of patients suffering from certain diseases. Because the number of the patients in a single hospital was limited and the training data was limited, it was feasible to use the data of multiple hospitals to train the model at the same time. Four hospitals respectively held data (X_{A}, y_{A}), (X_{B}, y_{B}), (X_{C}, y_{C}), (X_{D}, y_{D}),

$$X = [ \begin{matrix}{x}_{j} \\ … \\ {x}_{k}\end{matrix} ]$$

is training data,

$$y = [ \begin{matrix}{y}_{j} \\ … \\ {y}_{k}\end{matrix} ]$$

is the corresponding label thereof, xᵢ=[xᵢ¹, xᵢ², . . . , xᵢ^{m}]. The training data of four hospitals contained different samples, but they had the same features. For patient privacy reasons or other reasons, one hospital cannot share data with any other hospitals, so the data were kept locally. To solve this situation, four hospitals could jointly train a model by using the horizontal federated learning method for decision tree as shown below:

S101, based on the data held by all participants, the quantile sketch of each feature in the data feature set was looked up, and all data were split into different buckets according to the quantile sketch;

It was assumed that hospital A of four hospitals was the coordinator and the other three hospitals B, C and D were participants. The q quantile sketches of respective features were Qᵢ, Q₂, . . . , Q_{q-1}, and their percentages are q₁, q₂, q_{q-1}. According to the q quantile sketches, samples could be split into different buckets. That is, if the feature value of the sample met Qᵢ<x^{j}<Qᵢ₊₁, the samples were split to the (i+1)^{th} bucket for that feature. There were m features, so there were m kinds of splitting. The first-order derivative g and second-order derivative h of each sample were calculated, then the g and h of the samples split to the same bucket were added according to the splitting of samples, and the same operation was carried out for all features according to the splitting of the features to get the histogram of each feature involving g and h: {G₁ⁱ, . . . , G_{q}ⁱ}, {Q₁ⁱ, . . . , Q_{q}ⁱ}, i=1 . . . m.

S1011, hospitals A, B, C, D searched the quantile sketch of all data of each data feature in the data feature set by dichotomy, and published the quantile sketch to hospitals A, B, C, D, by which user data privacy could be protected while quickly and efficiently constructing the quantile sketch.

Firstly, the sum of number of samples, N, of four hospitals was calculated by secure aggregation. For each feature, set the maximum value and the minimum value of the feature values were Qₘₐₓ and Qₘᵢₙ respectively, then the first quantile can be set to Q=(Qₘₐₓ+Qₘᵢₙ)/2, and the number of samples n_{A}, n_{B}, n_{C}, n_{D} whose feature values were less than Q in the data sets X_{A}, X_{B}, X_{C}, X_{D} were counted separately. By using secure aggregation, hospital B, C and D sent n_{B}, n_{C}, n_{D} to hospital A to be merged with n_{A}, thereby obtaining n=n_{A}+n_{B}+n_{C}+n_{D}. If

$$\frac{n}{N} < {q}_{i} ,$$

then Qₘᵢₙ=Q; on the contrary, if

$$\frac{n}{N} > {q}_{i} ,$$

then Qₘₐₓ=Q, this process was cycled until

$$\frac{n}{N} = {q}_{i} ,$$

then the size of the i^{th} quantile could be calculated. By repeating the above process, the sizes of all quantiles could be calculated. In this process, hospitals will not expose the values of samples in the data set or the size of the data set, so as to protect the data privacy.

S1012, hospitals A, B, C and D respectively constructed local histograms of each feature in the data feature set according to the searched quantile sketch, and added noise to the local histograms according to the principle of differential privacy; then, hospitals B, C and D sent the local histograms added with the noise to hospital A through secure aggregation, and hospital A merged the local histograms of each data feature into a global histogram.

By using a label y, the first-order derivative g=ŷ−y and the second-order derivative h=ŷ(1−ŷ) could be calculated for each sample. For each feature, according to the splitting of samples, the g and h split to the same bucket were added separately to get the local histogram {G₁^{(j)}, . . . , G_{q}^{(j)}}, {Q₁^{(j)}, . . . , Q_{q}^{(j)}}, j∈{A, B, C, D} . By using secure aggregation, hospitals B, C and D sent their local histograms to hospital A, thereby obtaining the global histogram {G₁ . . . G_{q}}, {Q₁, . . . , Q_{q}}.

S102, according to the global histogram, hospital A trained the first node of the first tree and sent the node information to hospitals B, C and D.

According to the global histogram {G₁ⁱ, . . . , G_{q}ⁱ}, {Q₁ⁱ, . . . , Q_{q}ⁱ}, i=1 . . . m and the principle of Gradient Boosting Decision Tree, hospital A looked for the optimal division point of the optimal feature, that is, according to the splitting situation of a certain feature, if the optimal split was found between the i^{th} bucket and the (i+1)^{th} bucket, the samples from the first bucket to the i^{th} bucket were split to the left sub-node and the samples from the (i+1)^{th} bucket to the q^{th} bucket were split to the right sub-node. Hospital A announced the information of how buckets were split to other hospitals. At the same time, the quantile could be directly used as the split value of the node.

S103, according to the splitting information, hospitals A, B, C and D updated the local histograms again and merged the local histograms into global histograms.

According to the bucket split information, hospitals A, B, C and D could split the samples into two parts, which respectively corresponded to the sample splitting of left and right sub-nodes. For the samples of the left and right child nodes, hospitals A, B, C and D need to construct local histograms respectively, and hospitals B, C and D also use secure aggregation to transmit the local histograms to hospital A to merge them into global histograms;

S1031, updating the local histogram according to the splitting of buckets with different features and the splitting information of buckets. Specifically, due to the differences between different features, the splitting of buckets for different features was different. After obtaining the bucket splitting information of the last node, the buckets of this feature were split into left and right parts, which corresponded to the samples of the left and right child nodes respectively, that is, there were no samples in some buckets of the left and right child nodes. However, buckets with other features could still retain some samples. Therefore, it was necessary to re-split buckets for the left and right child nodes according to the initially constructed buckets, and build local histograms. The advantage of this method is that by constructing the quantile sketch only once, the communication complexity between hospitals is reduced, and the sorting information between samples is protected as much as possible.

S104, the above process were repeated until the training of all decision trees was completed.

Based on the global histogram of each node, step S102 was repeated to get the split values of sub-nodes, and this process was repeated to train a multi-layered tree. After the training of each tree was completed, the prediction results of each sample were updated. In the training process of the next tree number, the first-order derivative g and the second-order derivative h were updated.

The horizontal federated learning method based on the decision tree of the present disclosure can jointly train the decision tree model by using the data held by each participant without revealing the local data of the participants, and its privacy protection level meets the differential privacy, and the model training result is close to centralized learning.

It should be noted that when the data compression apparatus provided in the foregoing embodiment performs data compression, division into the foregoing functional modules is used only as an example for description. In an actual application, the foregoing functions can be allocated to and implemented by different functional modules based on a requirement, that is, an inner structure of the apparatus is divided into different functional modules, to implement all or some of the functions described above. For details about a specific implementation process, refer to the method embodiment. Details are not described herein again.

All or some of the foregoing embodiments may be implemented by using software, hardware, firmware, or any combination thereof. When the software is used for implementation, all or some of the embodiments may be implemented in a form of a computer program product. The computer program product includes one or more computer instructions. When the computer program instructions are loaded and executed on a server or a terminal, all or some of the procedures or functions according to the embodiments of this application are generated. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial optical cable, an optical fiber, or a digital subscriber line) or wireless (for example, infrared, radio, or microwave) manner. The computer-readable storage medium may be any usable medium accessible by a server or a terminal, or a data storage device, such as a server or a data center, integrating one or more usable media. The usable medium may be a magnetic medium (for example, a floppy disk, a hard disk, or a magnetic tape), an optical medium (for example, a digital video disk (DVD)), or a semiconductor medium (for example, a solid-state drive).

The steps of the method or algorithm described combined with the embodiments of the present disclosure may be implemented in a hardware manner, or may be implemented in a manner in which a processor executes software instructions. The software instructions may consist of corresponding software modules, and the software modules can be stored in Random Access Memory (RAM), flash memory, Read Only Memory (ROM), Erasable Programmable ROM (EPROM), Electrically Erasable Programmable Read-Only Memory (EEPROM), registers, hard disks, removable hard disks, CD-ROMs or any other forms of storage media well-known in the art. An exemplary storage medium is coupled to the processor, such that the processor can read information from, and write information to, the storage medium. The storage medium can also be an integral part of the processor. The processor and storage medium may reside in an Application Specific Integrated Circuit (ASIC). Alternatively, the ASIC may be located in a node device, such as the processing node described above. In addition, the processor and storage medium may also exist in the node device as discrete components.

The above description is only the preferred examples of the present disclosure, and it is not intended to limit the present disclosure. Any modification, equivalent replacement, improvement, etc. made within the spirit and principle of the present disclosure shall be included in the scope of protection of the present disclosure.

What is claimed is:

1. A federated learning method for decision tree-oriented horizontal, wherein the decision tree is Gradient Boosting Decision Trees, and the method comprises the following steps:
(1) all participants searching for a quantile sketch of all data of each feature in a data feature set by dichotomy, and publishing the quantile sketch to all participants;
(2) all participants respectively constructing local histograms of each feature in the data feature set according to the quantile sketch searched in step (1), and adding a noise to the local histograms according to the principle of differential privacy;
(3) subsequently, the participants except a coordinator sending the local histograms added with the noise to the coordinator through secure aggregation, wherein the coordinator is one of all participants;
(4) the coordinator merging the local histograms of each data feature into a global histogram, and training a root node of a first decision tree according to the global histogram;
(5) the coordinator sending node information to other participants, wherein the node information comprises a selected data feature and separation methods corresponding to the data feature in the global histogram;
(6) all participants updating the local histogram according to the node information;
(7) repeating steps (2)-(6) according to the updated local histograms until the training of remaining child nodes in the first decision tree is completed;
(8) repeating step (7) until the training of all decision trees is completed to obtain a final Gradient Boosting Decision Trees model.

2. The federated learning method for decision tree-oriented horizontal according to claim 1, wherein the data feature set is personal privacy information.

3. The federated learning method for decision tree-oriented horizontal according to claim 1, wherein the dichotomy in step (1) comprises:
(a) the coordinator obtaining a total number of samples held by all participants through a secure aggregation method;
(b) the coordinator setting a maximum value and a minimum value of each data feature, and taking an average value of the maximum value and the minimum value of each feature value as a quantile candidate value for the the data feature;
(c) the coordinator sending the quantile candidate values of all feature to other participants, all participants count the number of samples smaller than the quantile candidate value of each feature in the feature set, respectively, and sending the results to the coordinator via the secure aggregation method, the coordinator thus getting the total number of samples smaller than the quantile candidate value of each feature without knowing the information of other participants;
(d) the coordinator calculating a data percentage of the quantile candidate value according to the number of samples that counted in step (a) and the statistics got in step (c), if the data percentage is less than a data percentage of a target quantile, taking the quantile candidate value as the minimum value, and if the data percentage is greater than the data percentage of the target quantile, taking the quantile candidate value as the maximum value, the mean value as the quantile candidate value is recalculated, and the processes (c)-(d) are repeated until the data percentage of the quantile is equal to the data percentage of the target quantile;
(e) repeating the processes (b)-(d) to search for remaining quantiles, wherein all quantiles constitute the quantile sketch.

4. The federated learning method for decision tree-oriented horizontal according to claim 1, wherein the local histograms are composed of first-order derivatives and second-order derivatives of all sample, respectively.

5. The federated learning method for decision tree-oriented horizontal according to claim 1, wherein the method of training the root node of the first decision tree according to the global histogram specifically comprises: the coordinator traversing each feature in the data feature set and simultaneously traversing separation methods of the global histogram of the feature, obtaining an optimal separation method by calculation, and vertically divides the global histogram into two parts according to the separation method.

6. The federated learning method for decision tree-oriented horizontal according to claim 1, wherein the step (6) comprises the following sub-steps:
(6.1) all participants selecting a corresponding quantile as a value of the node according to the node information returned by the coordinator and referring to the quantile sketch;
(6.2) according to the value of the node, all participants splitting the samples they own to left and right sub-nodes of the node, wherein the samples with feature values smaller than the node value selected in the step (5) into the left sub-node, and the samples with feature values larger than the node value into the right sub-node; and updating the local histograms.
